(19) United States
(12) Patent Application Publication
(10) Pub. No.: US 2026/0361809 A1
(43) Pub. Date: Nov. 12, 2026

(54) METHOD AND APPARATUS OF DATA TRANSMISSION

(71) Applicant: Lenovo (Beijing) Limited, Beijing (CN)

(72) Inventors: Mingzeng Dai, Shanghai (CN); Xiaoying Xu, Shanghai (CN); Haiyan Luo, Shanghai (CN); Shuigen Yang, Shanghai (CN)

(73) Assignee: Lenovo (Beijing) Limited, Beijing (CN)

(21) Appl. No.: 19/128,506

(22) PCT Filed: Nov. 11, 2022
(86) PCT No.: PCT/CN2022/131431

§ 371 Date: May 8, 2025

(51) Int. Cl. H04L 69/322; H04L 5/00

(52) U.S. Cl. CPC H04L 69/322; H04L 5/0044

(57) ABSTRACT

Embodiments of the present application relate to a method and apparatus of data transmission. An exemplary method includes: determining to apply a first bearer type of a DRB to transmit a plurality of PDU set types, e.g., by a CU; and transmitting, to a DU coupled to the CU, an indication of the first bearer type of the DRB, and PDU set type information associated with different PDU set types; wherein, the first bearer type of the DRB is served by a plurality of logical channels, and each logical channel is for transmitting a respective one of the PDU set types.

### TECHNICAL FIELD

Embodiments of the present application generally relate to wireless communication technology, especially to a method and apparatus of data transmission, e.g., data transmission supporting data radio bearer (DRB) with different protocol data unit (PDU) set types.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) system (5GS) which may also be referred to as new radio (NR) systems.

On the other hand, extended reality (XR), including augmented reality (AR) and virtual reality (VR), as well as cloud gaming (CG), presents a new promising category of connected devices, applications, and services. Thus, 3rd generation partnership program (3GPP) has considered introducing XR into 3GPP, and the integration of XR applications within 5G system is approached following the model of 5G media streaming as defined in 3GPP. Accordingly, there are a mass of technical problems to be solved to support XR services (or applications, or traffics) in 5GS or in further LTE of radio access network (RAN).

For example, it is proposed to support differentiated quality of service (QoS) handling considering different importance of PDU sets, e.g. by treating packets (e.g. PDUs) belonging to less important PDU set(s) differently to reduce the resource wasting. Possible solutions are mapping PDU sets with different importance associated with the same traffic, e.g., XR service into one DRB, which can support reordering in PDCP layer among different PDU sets. However, issues on how to support configuration and data transmission of such a DRB over F1 interface need to be solved.

### SUMMARY OF THE APPLICATION

One objective of the embodiments of the present application is to provide a technical solution of data transmission, e.g., a method and apparatus of data transmission for XR services or the like over F1 interface, wherein PDU sets with different PDU set types belonging to the same XR service or the like can be mapped into the same DRB.

Some embodiments of the present application provide a central unit (CU) of a RAN node, e.g., a gNB-CU, which includes: a transceiver; and a processor coupled to the transceiver, wherein the processor is configured to: determine to apply a first bearer type of a DRB to transmit a plurality of PDU set types; and transmit, to a distributed unit (DU) of the RAN node, an indication of the first bearer type of the DRB, and PDU set type information associated with the plurality of PDU set types; wherein, the first bearer type of the DRB is served by a plurality of logical channels, and each logical channel is for transmitting a respective one of the PDU set types.

In some embodiments of the present application, there are a plurality of F1-U tunnels used for PDU set types between the CU and the DU, and each F1-U tunnel corresponds to a PDU set type.

According to some embodiments of the present application, the processor is further configured to: transmit, to the DU, uplink transport network layer (TNL) information for each F1-U tunnel of each PDU set type; and receive, from the DU, downlink TNL information for each F1-U tunnel of each PDU set type, wherein, the uplink TNL information for each F1-U tunnel of each PDU set type includes first uplink TNL information for one PDU set type and second uplink TNL information for each of remaining PDU set types, and the downlink TNL information for each F1-U tunnel of each PDU set type includes first downlink TNL information for the one PDU set type and second downlink TNL information for each of the remaining PDU set types.

According to some embodiments of the present application, the CU further includes a CU control plane (CP) and a CU user plane (UP) coupled to the CU CP, and wherein, the CU CP is configured to: determine the first bearer type for the DRB, and transmit the indication of the first bearer type of the DRB and the PDU set type information to both the DU and the CU UP.

In some cases, the CU UP is configured to: receive the indication of the first bearer type of the DRB and the PDU set type information from the CU CP; allocate uplink TNL information for each F1-U tunnel of each PDU set type based on the indication of the first bearer type of the DRB and the PDU set type information; transmit the uplink TNL information for each F1-U tunnel of each PDU set type to the CU CP; and receive downlink TNL information for each F1-U tunnel of each PDU set type forwarded by the CU CP that is received from the DU.

In some cases, the CU CP is further configured to: receive uplink TNL information for each F1-U tunnel of each PDU set type from the CU CP; transmit the received uplink TNL information for each F1-U tunnel of each PDU set type to the DU; receive downlink TNL information for each F1-U tunnel of each PDU set type from the DU; and transmit the downlink TNL information for each F1-U tunnel of each PDU set type to the CU UP.

According to some embodiments of the present application, the processor is configured to: in the case of a plurality of PDU sets with the plurality of PDU set types belonging to a traffic from a core network, map the plurality of PDU sets to the DRB in a service data adaptation protocol (SDAP) entity, and send packet data convergence protocol (PDCP) PDUs of the plurality of PDU sets to different F1-U tunnels correspondingly; and in the case of a plurality of PDU sets with the plurality of PDU set types belonging to a traffic from a user equipment, receive PDCP PDUs of the plurality of PDU sets via different F1-U tunnels.

In some embodiments of the present application, there is one common F1-U tunnel used for the plurality of PDU set types between the CU and DU.

According to some embodiments of the present application, the processor is configured to receive flow control information corresponding to each PDU set type from the DU.

In some cases, the flow control information indicates at least one of the following information: a highest PDCP PDU sequence number successfully delivered in sequence to a user equipment of a PDU set type; a highest PDCP PDU sequence number transmitted to lower layers of a PDU set type; or a desired buffer size for the PDU set type of the DRB.

In some cases, the flow control information is indicated in a downlink data delivery status frame with a PDU set type indication.

In some embodiments of the present application, the plurality of PDU set types have different importance.

In some embodiments of the present application, each radio link control (RLC) entity corresponds to each logical channel.

Some other embodiments of the present application provide a DU of a RAN node, e.g., a gNB-DU, which includes: a transceiver; and a processor coupled to the transceiver, wherein the processor is configured to: receive, from a CU of the RAN node, a PDU set type information associated with a plurality of PDU set types; determine a first bearer type of a DRB for a plurality of PDU set types; and transmit, to the CU, an indication of the first bearer type of the DRB; wherein the first bearer type of the DRB is associated with a plurality of logical channels, and each logical channel is for transmitting a respective one of the PDU set types.

In some embodiments of the present application, there are a plurality of F1-U tunnels used for PDU set types between the CU and the DU, and each F1-U tunnel corresponds to a PDU set type.

According to some embodiments of the present application, the processor is further configured to: receive, from the CU, uplink TNL information for each F1-U tunnel of each PDU set type; and transmit, to the CU, downlink TNL information for each F1-U tunnel of each PDU set type, wherein, the uplink TNL information for each F1-U tunnel of each PDU set type includes first uplink TNL information for one PDU set type and second uplink TNL information for each of remaining PDU set types, and the downlink TNL information for each F1-U tunnel of each PDU set type includes first downlink TNL information for the one PDU set type and second downlink TNL information for each of the remaining PDU set types.

In some cases, the downlink TNL information for each F1-U tunnel of each PDU set type is transmitted with the indication indicating that the certain bearer type is applied for the DRB or after receiving the uplink TNL information for each F1-U tunnel of each PDU set type.

In some cases, the first uplink TNL information is received with the PDU set type information or after transmitting the indication of the first bearer type of the DRB, and the second uplink TNL information is received after transmitting the indication of the first bearer type of the DRB.

In some cases, the first downlink TNL information is transmitted with the indication of the first bearer type of the DRB, and the second downlink TNL information is transmitted also with the indication of the first bearer type of the DRB is applied for the DRB or after receiving the second uplink TNL information.

In some cases, the CU further includes a CU CP and a CU UP coupled to the CU CP, and wherein, the uplink TNL information for each F1-U tunnel of each PDU set type is received from the CU CP and the downlink TNL information for each F1-U tunnel of each PDU set type is transmitted to the CU CP.

According to some embodiments of the present application, wherein, the processor is further configured to: allocate different logical channel identities for the plurality of PDU set types based on the PDU set type information; and transmit logical channel information indicating the different logical channel identities to the CU with the indication of the first bearer type of the DRB.

According to some embodiments of the present application, the processor is configured to: in the case of a plurality of PDU sets with the plurality of PDU set types belonging to a traffic from a core network, receive PDCP PDUs of the plurality of PDU sets from different F1-U tunnels correspondingly; and in the case of a plurality of PDU sets with the plurality of PDU set types belonging to a traffic from a user equipment, transmit PDCP PDUs of the plurality of PDU sets identified to different F1-U tunnels.

In some embodiments of the present application, the CU further includes a CU CP and a CU UP coupled to the CU CP, wherein, the PDU set type information is received from the CU CP and the indication of the first bearer type of the DRB is transmitted to the CU CP.

In some embodiments of the present application, there is one common F1-U tunnel used for the plurality of PDU set types between the CU and DU.

According to some embodiments of the present application, the processor is configured to transmit flow control information corresponding to each PDU set type to the CU.

Some yet other embodiments of the present application also provide a DU of a RAN node, e.g., a gNB-DU, which includes: a transceiver; and a processor coupled to the transceiver, wherein the processor is configured to: receive, from a CU of the RAN node, an indication of a first bearer type of a DRB and PDU set type information associated with different PDU set types, wherein, the first bearer type of the DRB is served by a plurality of logical channels, and each logical channel is for transmitting a respective one of the PDU set types; and allocate different logical channels for different PDU set types based on the indication of the first bearer type of the DRB and the PDU set type information.

Some yet other embodiments of the present application also provide a CU of a RAN node, e.g., a gNB-CU, which includes: a transceiver; and a processor coupled to the transceiver, wherein the processor is configured to: transmit, to a DU of the RAN node, PDU set type information associated with a plurality of PDU set types; and receive, from the DU, an indication of a first bearer type of a DRB; wherein the first bearer type of the DRB is associated with a plurality of logical channels, and each logical channel is for transmitting a respective one of the PDU set types.

Given the above, embodiments of the present application provide a technical solution of data transmission, wherein PDU sets with different PDU set types of the same traffic, e.g., of the same XR services can be mapped into the same DRB. Issues on how to support configuration and data transmission of the same DRB carrying different PDU set types over F1 interface are solved. Accordingly, the present application can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application.

FIG. 2 is a schematic diagram illustrating an internal structure of a RAN node according to some embodiments of the present application.

FIG. 3 is a schematic diagram illustrating an internal structure of a RAN node according to some other embodiments of the present application.

FIG. 4 illustrates a schematic diagram of an internal structure of a RAN node for data transmission of an exemplary new type DRB according to some embodiments of the present application.

FIG. 5 illustrates a schematic diagram of an internal structure of a RAN node for data transmission of an exemplary new type DRB according to some other embodiments of the present application.

FIG. 6 is a flow chart illustrating a method of data transmission in Scenario 1 according to some embodiments of the present application.

FIG. 7 is a flow chart illustrating a method of data transmission in Scenario 1 according to some other embodiments of the present application.

FIG. 8 is a flow chart illustrating a method of data transmission in Scenario 2 according to some embodiments of the present application.

FIG. 9 is a flow chart illustrating a method of data transmission in Scenario 2 according to some other embodiments of the present application.

FIG. 10 is a flow chart illustrating a method of data transmission in Scenario 1 according to some yet embodiments of the present application.

FIG. 11 illustrates a block diagram of an apparatus of data transmission according to some embodiments of the present application.

FIG. 12 illustrates a block diagram of an apparatus of data transmission according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, and so on. It is contemplated that along with the developments of network architectures and new service scenarios, all embodiments in the present application are also applicable to similar technical problems. Moreover, the terminologies recited in the present application may change, which should not affect the principle of the present application.

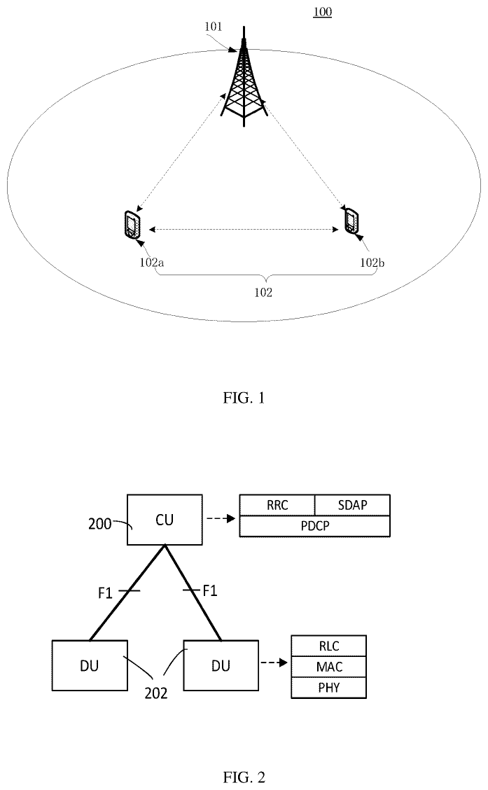

FIG. 1 illustrates a schematic diagram of an exemplary wireless communication system 100 according to some embodiments of the present application.

As shown in FIG. 1, the wireless communication system 100 includes at least one base station (BS) 101 and at least one UE 102. In particular, the wireless communication system 100 includes one BS 101 and two terminal device 102 (e.g., a first UE 102a and a second UE 102b) for illustrative purpose. Although a specific number of BSs and terminal devices are illustrated in FIG. 1 for simplicity, it is contemplated that the wireless communication system 100 may include more or less BSs and terminal devices in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a core network (CN) node (not shown), e.g., a mobility management entity (MME) or a serving gateway (S-GW), an authentication and mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node. Each BS may serve a number of UE(s) within a serving area, for example, a cell or a cell sector via a wireless communication link. Neighbor BSs may communicate with each other as necessary, e.g., during a handover procedure for a UE.

The terminal device (or remote apparatus) 102, e.g., the first UE 102a and the second UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the terminal device may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the terminal device may include wearable devices, such as smart watches, fitness bands, optical head-mounted displays, or the like. Moreover, the terminal device may be referred to as a subscriber unit, a mobile, a mobile station, a user, a terminal, a mobile terminal, a wireless terminal, a fixed terminal, a subscriber station, a user terminal, or a device, or described using other terminology used in the art. Herein (through the specification), although “UE” is used exemplarily as a classical terminal device for illustrating the terminal device, it should be understood as any type terminal device.

FIG. 2 is a schematic diagram illustrating an internal structure of a RAN node, e.g., a BS according to some embodiments of the present application.

Referring to FIG. 2, in a split RAN architecture, the internal structure of a RAN node (e.g., BS 101) may be split into a CU 200 and at least one DU 202 (e.g., two DUs shown in FIG. 2). Although a specific number of DUs 202 are depicted in FIG. 2, it is contemplated that any number of DUs 202 may be included in the BS.

The CU 200, e.g., a CU of a gNB (gNB CU, or gNB-CU) and DU 202 e.g., a DU of a gNB (gNB DU, or gNB-DU) are connected with each other by an interface called F1 as specified in 3GPP standard documents. The RRC layer functionality, SDAP functionality, and the PDCP layer functionality are located in the CU 200. The RLC layer functionality, MAC layer functionality, and the PHY layer functionality are located in the DU 202.

According to some embodiments of the present application, the CU may be separated into a CU CP unit (also referred to as “CU CP” or “CU-CP”) and at least one CU UP unit (or also referred to as “CU UP” or “CU-UP”).

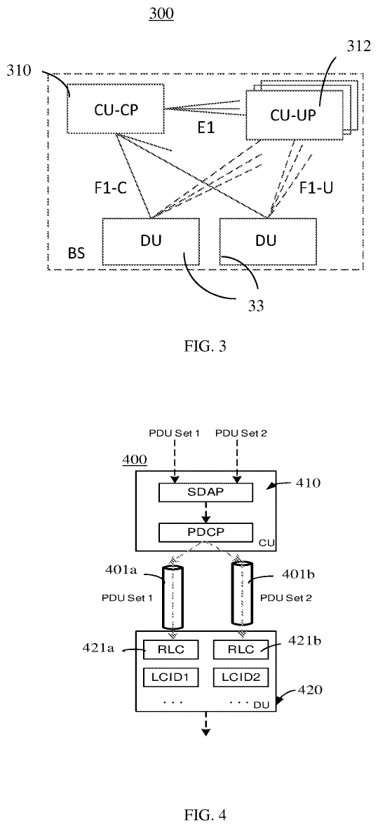

FIG. 3 is a schematic diagram illustrating an internal structure of a BS 300 according to some other embodiments of the present application.

Referring to FIG. 3, the CU of the BS 300 may be separated into a CU-CP unit 310 and at least one CU-UP 312. The CU-CP unit 310 and each CU-UP unit 312 may be connected with each other by an interface called E1 as specified in 3GPP standard documents. The CU-CP unit 310 and the DU 33 of the BS 300 are connected by an interface called F1-C as specified in 3GPP documents. Each CU-UP unit 312 and the DU 33 are connected by an interface called F1-U as specified in 3GPP standard documents.

When integrating XR applications into 5GS, a PDU set and PDU set QoS characteristics may be introduced as discussed in TR 23.700-60. A PDU set is composed of one or more PDUs carrying the payload of one unit of information generated at the application level (e.g. a frame or video slice for XR management services, as used in TR 26.926). In some implementations, all PDUs in a PDU set are needed by the application layer to use the corresponding information unit. In some other implementations, when some PDUs are missing, the application layer can still recover part(s) or all of the information unit(s).

There are various types of PDU sets. For example, different types of PDU sets can carry different contents, such as intra-coded pictures (also referred to as “I-frame”), predictive coded pictures (also referred to as “P-frame”), B-predictive coded pictures (also referred to “B-frame”). In another example, different types of PDU sets may have different importance or different priority levels. A PDU set may be characterized by a notion of “importance” indicating how important the PDU set (e.g., a video frame) is for an application. For example, an important PDU set may be an I-Frame, while a less important PDU set may be a P-Frame.

At least to support reordering function and in-order delivery, mapping different types of PDU sets to one DRB is needed, and the DRB may be configured with different RLC entities (e.g., at least two), whose logical channels (LCH)s have different priorities. A new type (hereafter, referred to a new DRB type or a new bearer type) of such a DRB carrying different PDU set types is provided according to embodiments of the present application, wherein, according to the new DRB type or new bearer type, the DRB is served by a plurality of logical channels, and each logical channel is for transmitting a respective one of the PDU set types. For example, in some embodiments of the present application, the DRB is served by one SDAP entity (or SDAP functionality, SDAP function etc.) and one PDCP entity (or PDCP functionality, PDCP function etc.), but will be served by different (e.g., at least two) RLC entities (or RLC functionalities, RLC functions etc.) and different logical channels, each RLC entity and logical channel corresponding to a PDU set type. Hereafter, a DRB with the new DRB type or new bearer type is also called a new DRB or a new type DRB for simplicity.

Compared with split bearer in dual connectivity (DC), the new type DRB is served by one cell or one cell group in a single DU of a RAN node, e.g., a gNB-DU, while the split bearer in dual connectivity is served by different cell groups on different gNB-DUs. Thus, the data transmission and configuration procedures over F1 interface are different from dual connectivity. Accordingly, issues on how to support configuration and data transmission of the new type DRB over F1 interface should be solved, which include but not limited to the following:
how to support F1-U tunnels for the data transmission of the new type DRB; and
how to decide (or determine or allocate) and configure the RLC entities and logical channels for different PDU sets between the CU and DU, e.g., between the gNB-CU and gNB-DU.

At least considering the above issues, embodiments of the present application propose a technical solution of data transmission, e.g., for data transmission of the new type DRB of XR services.

According to embodiments of the present application, whether to apply the new bearer type of a DRB (or, whether to apply the new bearer type for a DRB, or whether the new bearer type or legacy bearer type is used for the DRB, or similar) to transmit a plurality of PDU sets types is determined or decided by one of a CU and a DU (any one of DUs coupled to the CU) within a RAN node. In response to deciding to apply the new bearer type for a DRB, an indication indicating that the certain bearer type is applied for the DRB (or indication of the certain bearer type of the DRB or similar) is transmitted to the other one of the CU and DU.

For example, in some embodiments of the present application, whether to apply the new bearer type for a DRB is decided by a CU, e.g., a gNB-CU (Scenario 1). An exemplary method of data transmission in Scenario 1 includes: determining to apply a certain bearer type (e.g., the new bearer type or new DRB type as stated above) of a DRB to transmit a plurality of PDU set types. The certain bearer type of the DRB is served by a plurality of logical channels, and each logical channel is for transmitting a respective one of the PDU set types. The plurality of PDU set types have different importance. Each RLC entity corresponds to each logical channel.

The method further includes transmitting to a DU coupled to the CU, an indication of the first bearer type of the DRB, and PDU set type information associated with different PDU set types.

In some other embodiments of the present application, whether to apply the new bearer type of a DRB is decided by a DU, e.g., a gNB-DU (Scenario 2). An exemplary method of data transmission in Scenario 2 includes: receiving, from a CU coupled to the DU, PDU set type information associated with different PDU set types; and determining to apply a certain bearer type (e.g., the new bearer type or new DRB type as stated above) of the DRB for a plurality of PDU set types, wherein, the certain bearer type of the DRB is associated with a plurality of logical channels, and each logical channel is for transmitting a respective one of the PDU set types. The method also includes transmitting, to the CU, an indication of the first bearer type of the DRB.

According to some embodiments of the present application, considering the new bearer type, there will be a plurality of F1-U tunnels between the CU and the DU, each F1-U tunnel corresponding to a PDU set type, which is novel over the legacy. An exemplary F1-U tunnel means a general packet radio service (GPRS) tunnel protocol user plane (GTP-U) tunnel for data transmission over F1 interface, wherein, the GTP-U tunnel is usually identified by a GTP-U tunnel endpoint identifier (TEID).

FIG. 4 illustrates a schematic diagram of an internal structure of a RAN node for data transmission of an exemplary new type DRB according to some embodiments of the present application, wherein a plurality of F1-U tunnels are provided for the new type DRB.

Referring to FIG. 4, the internal structure of a RAN node 400, e.g., a gNB may be split into a CU 410, e.g., a gNB-CU and at least one DU 420 (herein, only one DU, e.g., a gNB-DU is shown for simplicity). It is assumed that there are two PDU set types for a new type DRB: PDU set type 1 (or type 1), e.g., important PDU set(s), and PDU set type 2 (or type 2), e.g., less important (or unimportant) PDU set(s), and there are two F1-U tunnels between the gNB-CU 410 and gNB-DU 420, each corresponding to a PDU set type. For example, a first F1-U tunnel 401a corresponds to PDU set type 1 and a second F1-U tunnel 401b corresponds to PDU set type 2.

Taking downlink data transmission as an example, in the case of receiving different PDU sets with different types of a traffic from the CN (not shown), e.g., PDU Set 1 with type 1 and PDU Set 2 with type 2, the gNB-CU 410 will map the different PDU sets into one DRB in one SDAP entity, that is, the SDAP entity is common for different PDU set types. After processing by one PDCP entity, the gNB-CU 410 will send the PDCP PDUs of PDU Set 1 to the gNB-DU 420 via the first F1-U tunnel 401s and send the PDCP PDUs of PDU Set 2 to the gNB-DU 420 via the second F1-U tunnel 401b correspondingly. The gNB-DU 420 will identify the PDU sets with different types according to the different F1-U tunnels and map the received PDCP PDUs to the corresponding RLC entity and logical channel for transmitting the data to UE (not shown). For example, PDCP PDUs of PDU Set 1 received from the first F1-U tunnel 401a will be mapped to the first RLC entity 421a and the first logical channel with logical channel identity (LCID) 1, and PDCP PDUs of PDU Set 2 received from the second F1-U tunnel 401b will be mapped to the second RLC entity 421b and the second logical channel with LCID 2.

According to some other embodiments of the present application, similar to the legacy, there will still be one F1-U tunnel between the CU and DU corresponding to all the different PDU set types even considering the new bearer type, that is, the F1-U tunnel is common to all PDU set types, and can also be referred to as a common F1-U tunnel.

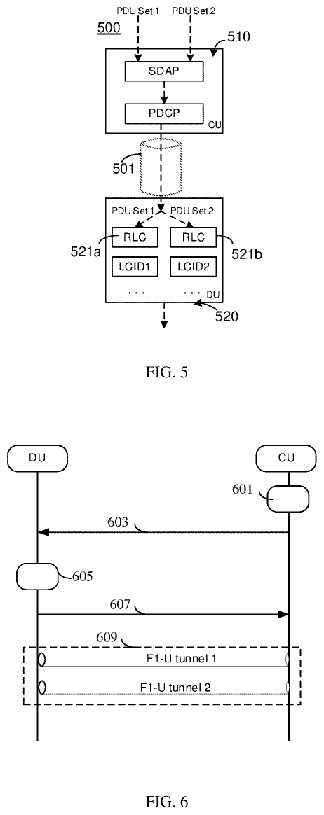

FIG. 5 illustrates a schematic diagram of an internal structure of a RAN node for data transmission of an exemplary new type DRB according to some other embodiments of the present application, wherein only one F1-U tunnel is provided for the new type DRB.

Referring to FIG. 5, the internal structure of a RAN node 500, e.g., a gNB may be split into a CU 510, e.g., a gNB-CU and at least one DU 520 (herein, only one DU, e.g., a gNB-DU is shown for simplicity). Similarly, it is assumed that there are two PDU set types for a new type DRB: PDU set type 1 (or type 1), e.g., important PDU set(s), and PDU set type 2 (or type 2), e.g., less important (or unimportant) PDU set(s). However, there is only one F1-U tunnel 501 between the gNB-CU 510 and gNB-DU 510 used for data transmission of all types of PDU sets.

Still taking downlink data transmission as an example, in the case of receiving different PDU sets with different types of a traffic from the CN, e.g., PDU Set 1 with type 1 and PDU Set 2 with type 2, the gNB-CU 510 will map the PDU sets with different types into one DRB in one SDAP entity. After processing by one PDCP entity, the gNB-CU 510 will send the PDCP PDUs of PDU Set 1 and the PDCP PDUs of PDU Set 2 via the only one F1-U tunnel 501 to the gNB-DU 520. The gNB-DU 520 will identify the different types of PDU sets according to specific PDU set type indication, which may be included in the header of the common F1-U tunnel, e.g., PDU set 1 being type1, or PDU set 2 being type 2 etc. Then, the gNB-DU 520 will map the received PDCP PDUs of different PDU sets to the corresponding RLC entities and logical channels for transmitting the data to UE (not shown). For example, PDCP PDUs of PDU Set 1 will be mapped to the first RLC entity 521a and the first logical channel identified by LCID 1 and PDCP PDUs of PDU Set 2 will be mapped to the second RLC entity 521b and the second logical channel identified by LCID 2.

More detailed embodiment of the present application will be illustrated hereafter in view of different scenarios. Although various information may be transmitted or received in the same message in some illustrated cases, persons skilled in the art should well know that they are only for illustration and may be transmitted or received in separated messages in some other cases according to embodiments of the present application.

FIG. 6 is a flow chart illustrating a method of data transmission in Scenario 1 according to some embodiments of the present application, wherein a plurality of F1-U tunnels are provided for a new type DRB. Although the method is illustrated in a system level between the CU of the RAN node, e.g., a gNB-CU and a DU coupled to the CU, e.g., a gNB-DU, persons skilled in the art should understand that the method implemented in the CU and the DU can be separately implemented and/or incorporated by other apparatus with the like functions.

Referring to FIG. 6, the gNB-CU may decide to apply a certain bearer type to a DRB in step 601 in some cases, e.g., in response to related information from the CN. The certain bearer type is the new bearer type or new DRB type as stated above. Exemplary related information may be QoS flow information or QoS parameters of PDU sets from the CN. For example, the related information from the CN may indicate that two (or more) different types of PDU sets, which may be carried by different QoS flows, i.e., using different QoS flows for different priority level PDU sets. The gNB-CU may decide to map the two QoS flows to the new type DRB, so that the DRB is served by one SDAP layer, one PDCP layer, and at least two RLC entities and logical channels, each RLC entity and logical channel corresponding to a PDU set type.

In step 603, the gNB-CU sends DRB to be setup information, e.g., DRB to Be Setup information element (IE) to a gNB-DU coupled to the gNB-CU for setup of the new type DRB. The DRB to be setup information may be included in a UE CONTEXT SETUP REQUEST message or UE CONTEXT MODIFICATION REQUEST message or the like. Exemplary DRB to be setup information may include an indication indicating that the certain bearer type of the DRB is applied (hereafter, also referred to as “new bearer type indication” or “new type DRB indication” or similar). For example, the new bearer type indication is an explicit indication or implicit indication used to indicate that the DRB to be setup is a new type DRB. The exemplary DRB to be setup information may also include PDU set type information, indicating different PDU set types carried by the DRB in various manners. For a DRB with two different PDU set types, exemplary PDU set type information may indicate: PDU set type 1 and PDU set type 2, wherein, PDU set type 1 indicates PDU set(s) with high importance, and PDU set type 2 indicates PDU set(s) with less importance; while another exemplary PDU set type information may indicate: PDU set(s) with high importance, PDU set(s) with less importance or the like. In some other cases, the PDU set type indicating high importance is defined as primary PDU set, while the PDU set type indicating less importance is called as secondary PDU set, and thus yet another exemplary PDU set type information may indicate: primary PDU set and secondary PDU set.

The gNB-CU may also transmit uplink (UL) TNL information for each F1-U tunnel of each PDU set type to the gNB-DU, which may also be included in the DRB to be setup information. The UL TNL information for each F1-U tunnel of each PDU set type includes first UL TNL information for one PDU set type of the different PDU set types and second UL TNL information for each of remaining PDU set types. The UL TNL information for each F1-U tunnel of each PDU set types also includes each UL TNL information for each PDU set type of the different PDU set types. For example, the UL TNL information for each F1-U tunnel of each PDU set type includes the UL TNL information for F1-U tunnel of the PDU set type indicating high importance and the UL TNL information for F1-U tunnel of the PDU set type indicating less importance. In some cases, the gNB-CU may separately transmit the UL TNL information for a corresponding F1-U tunnel of a PDU set type, for example, separately transmitting the first UL TNL information and the second UL TNL information to the gNB-DU. In view of each F1-U tunnel, the corresponding UL TNL information is the CU endpoint of the corresponding F1-U tunnel for delivery of UL PDU sets, which may contain a transport layer address (e.g., internet protocol (IP) address) and a GTP TEID.

After receiving the new bearer type indication, the gNB-DU will be aware that the new type DRB is to be setup. The gNB-DU will allocate related parameters for the new bearer type DRB in step 605. For example, considering two PDU set types, the gNB-DU allocates two RLC entities and two logical channels (or LCIDs) for the new type DRB, each RLC entity and logical channel (or, LCID) is for a corresponding PDU set type. The modes of the RLC entities and the priorities of the logical channels will be configured according to the PDU set type information. For example, the gNB-DU may allocate RLC-acknowledge mode (AM) and high priority logical channel for the PDU set type indicating high importance, while allocate RLC-unacknowledged mode (UM) and low priority logical channel for the PDU set type indicating less importance.

The gNB-DU will also allocate or determine downlink (DL) TNL information for each F1-U tunnel of each PDU set type. Similarly, the DL TNL information for each F1-U tunnel of each PDU set type includes first DL TNL information for one PDU set type of the different PDU set types and second DL TNL information for each of remaining PDU set types. The DL TNL information for each F1-U tunnel of each PDU set types also includes each DL TNL information for each PDU set type of the different PDU set types. For example, considering two PDU set types of high importance and less importance, the DL TNL information for each F1-U tunnel of each PDU set type may include: the DL TNL information for the PDU set type indicating high importance and the DL TNL information for the PDU set type indicating less importance. In view of each F1-U tunnel, the corresponding DL TNL information is the DU endpoint of the corresponding F1-U tunnel for delivery of DL PDU sets, which may contain a transport layer address (e.g., an IP address) and a GTP TEID.

The gNB-DU will transmit DRB to setup information, e.g., DRB to Setup IE to the gNB-CU in step 607. The DL TNL information for each F1-U tunnel of each PDU set type may be included in the DRB to setup information to the gNB-CU in step 607. The DRB to setup information may be included in a UE CONTEXT SETUP RESPONSE message in response to the UE CONTEXT SETUP REQUEST message, or in a UE CONTEXT MODIFICATION RESPONSE message in response to the UE CONTEXT MODIFICATION REQUEST message. In some cases, the gNB-DU may separately transmit the DL TNL information for a corresponding F1-U tunnel of a PDU set type, for example, separately transmitting the first DL TNL information and the second DL TNL information to the gNB-CU.

After the new type DRB is setup, data transmission will be performed over the F1 interface in step 609.

Specifically, in the case of receiving a plurality of PDU sets with different PDU set types belonging to a traffic (e.g., XR services) from a core network, the gNB-CU will map the plurality of PDU sets to the setup DRB in the SDAP entity. After processing by the PDCP entity, the gNB-CU sends PDCP PDUs of the plurality of PDU sets to the gNB-DU via different F1-U tunnels correspondingly. For example, for PDU Set 1 with PDU set type 1 indicating PDU set with high importance and PDU Set 2 with PDU set type 2 indicating PDU set with less importance, based on the DL TNL information for each F1-tunnel of each PDU set type, the gNB-CU will send the PDCP PDUs of PDU Set 1 via F1-U tunnel 1 to the gNB-DU while send PDCP PDUs of PDU Set 2 via F1-U tunnel 2 to the gNB-DU. The gNB-DU will identify the PDU sets with different types according to the F1-U tunnels and map the received PDCP PDUs to the corresponding RLC entity and logical channel for transmitting data to corresponding UE.

In the case of a plurality of PDU sets with the different PDU set types belonging to a traffic (e.g., XR services) from a UE, the gNB-DU transmits PDCP PDUs of the plurality of PDU sets to the gNB-CU via different F1-U tunnels. For example, for PDU Set 1 with high importance and for PDU Set 2 with less importance received from the UE, based on the UL TNL information for each F1-tunnel of each PDU set type, the gNB-DU will send the PDCP PDUs of PDU Set 1, e.g., identified by LCID 1 via F1-U tunnel 1 to the gNB-CU while sends PDCP PDUs of PDU Set 2, e.g., identified by LCID 2 via F1-U tunnel 2 to the gNB-CU.

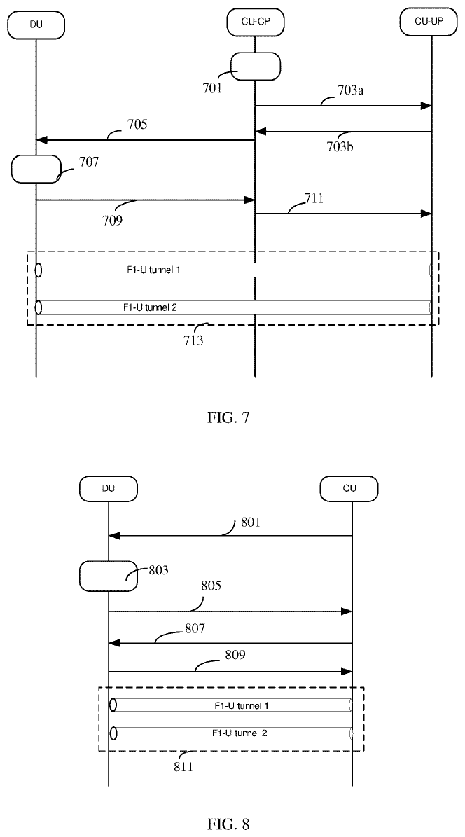

Considering the cases of a split CU, embodiments illustrated in view of FIG. 6 can be further detailed within the CU as shown in FIG. 7. Specifically, FIG. 7 is a flow chart illustrating a method of data transmission in Scenario 1 according to some other embodiments of the present application, wherein a plurality of F1-U tunnels are provided for the new type DRB.

Referring to FIG. 7, the CU of a RAN node, e.g., a gNB-CU is separated into a CU-CP and at least one CU-UP coupled to the CU-CP (only one is illustrated as an example). Similarly, although the method is illustrated in a system level between the CU of the RAN node e.g., a gNB-CU and a DU coupled to the CU, e.g., a gNB-DU, persons skilled in the art should understand that the method implemented in the CU and the DU can be separately implemented and/or incorporated by other apparatus with the like functions.

Similar to step 601, the CU-CP will determine whether to apply the new bearer type for a DRB in step 701. For example, the CU-CP may decide to apply the new bearer type for the DRB in response to QoS flow information or QoS parameters of PDU sets from the CN.

In step 703a, the CU-CP will send a new bearer type indication to the CU-UP over E1 interface, e.g., included in DRB to Be Setup IE or the like, via a BEARER CONTEXT SETUP REQUEST message. The CU-CP may also transmit PDU set type information indicating different PDU set types carried by the DRB to the CU-UP, e.g., also included in the DRB to Be Setup IE or the like.

After receiving the new bearer type indication and PDU set type information, the CU-UP will allocate UL TNL information for each F1-U tunnel of each PDU set type as stated in FIG. 6. The CU-UP will send the UL TNL information for each F1-U tunnel of each PDU set type to the CU-CP in step 703b, e.g., via a BEARER CONTEXT SETUP RESPONSE message in response to the BEARER CONTEXT SETUP REQUEST message.

In step 705, the CU-CP will transmit DRB to be setup information, e.g., DRB to Be Setup IE to the DU, which is identical or similar to step 603.

Similar to step 605, after receiving the new bearer type indication and PDU set type information, the DU will allocate parameters for the new bearer type DRB in step 707. The DU will also allocate DL TNL information for each F1-U tunnel of each PDU set type.

Similar to step 607, the DU will transmit DRB to setup information, e.g., DRB to Setup IE to the CU-CP in step 709, and the DL TNL information for each F1-U tunnel of each PDU set type may also be included in the DRB to setup information.

After receiving the DL TNL information for each F1-U tunnel of each PDU set type from the DU, the CU-CP will transmit it to the CU-UP in step 711, e.g., via a BEARER CONTEXT MODIFY REQUEST message.

After the new type DRB is setup, data transmission will be performed over the F1 interface in step 713.

Specifically, for a plurality of PDU sets with different PDU set types belonging to a traffic (e.g., XR services) from a core network, the CU-UP will map the different types of PDU sets to one DRB in SDAP entity. After processing by one PDCP entity, the CU-UP will send PDCP PDUs of the plurality of PDU sets to the DU via different F1-U tunnels correspondingly. For example, for PDU Set 1 with PDU set type 1 indicating PDU set with high importance and PDU Set 2 with PDU set type 2 indicating PDU set with less importance, based on the DL TNL information for each F1-tunnel of each PDU set type, the CU-UP will send the PDCP PDUs of PDU Set 1 via F1-U tunnel 1 to the DU while send PDCP PDUs of PDU Set 2 via F1-U tunnel 2 to the DU. The DU will identify the PDU sets with different types according to the F1-U tunnels and map the received PDCP PDUs to the corresponding RLC entity and logical channel for transmitting data to corresponding UE.

In the case of receiving a plurality of PDU sets with the different PDU set types belonging to a traffic (e.g., XR services) from a UE, the DU will transmit PDCP PDUs of the plurality of PDU sets to the CU-UP via different F1-U tunnels. For example, for PDU Set 1 with high importance and for PDU Set 2 with less importance received from the UE, based on the UL TNL information for each F1-tunnel of each PDU set type, the gNB-DU will send the PDCP PDUs of PDU Set 1, e.g., identified by LCID 1 via F1-U tunnel 1 to the CU-UP while send PDCP PDUs of PDU Set 2, e.g., identified by LCID 2 via F1-U tunnel 2 to the CU-UP.

FIG. 8 is a flow chart illustrating a method of data transmission in Scenario 2 according to some embodiments of the present application, wherein a plurality of F1-U tunnels are provided for a new type DRB. Although the method is illustrated in a system level between the CU of the RAN node, e.g., a gNB-CU and a DU coupled to the CU, e.g., a gNB-DU, persons skilled in the art should understand that the method implemented in the CU and the DU can be separately implemented and/or incorporated by other apparatus with the like functions.

Referring to FIG. 8, for a DRB to be setup, the gNB-CU will send DRB to be setup information, e.g., DRB to Be Setup IE to a gNB-DU coupled to the gNB-CU in step 801. The DRB to be setup information may be included in a UE CONTEXT SETUP REQUEST message or a UE CONTEXT MODIFICATION REQUEST message or the like. The DRB to be setup information may include PDU set type information indicating different PDU set types carried by the DRB. For a DRB with two different PDU set types, exemplary PDU set type information may indicate: PDU set type 1 and PDU set type 2, wherein, PDU set type 1 indicates PDU set(s) with high importance, and PDU set type 2 indicates PDU set(s) with less importance. In some other cases, exemplary PDU set type information may indicate: PDU set(s) with high importance, PDU set(s) with less importance or the like. In some yet other cases, the PDU set type indicating high importance is defined as primary PDU set, while the PDU set type indicating less importance is called as secondary PDU set, and thus exemplary PDU set type information may indicate: primary PDU set and secondary PDU set.

After receiving the PDU set type information from the gNB-CU, e.g., indicated in the DRB to be setup information, the gNB-DU will decide whether to apply the new bearer type for the DRB according to the PDU set type information in step 803.

In the case that the gNB-DU decides to use the new bearer type for the DRB, the gNB-DU will allocate related parameters for the new type DRB similar to step 605. For example, considering two PDU set types, the gNB-DU allocates two RLC entities and two logical channels (or LCID) for the new type DRB, each RLC entity and logical channel (or LCID) is for a corresponding PDU set type. The modes of the RLC entities and the priorities of the logical channels will be configured according to the PDU set type information. For example, the gNB-DU may allocate RLC-AM and high priority logical channel for the PDU set type indicating high importance, while allocate RLC-UM and low priority logical channel for the PDU set type indicating less importance.

In step 805, the gNB-DU will transmit DRB to setup information, e.g., DRB to Setup IE for the new DRB setup to the gNB-CU. The DRB to setup information may be included in a UE CONTEXT SETUP RESPONSE message or a UE CONTEXT MODIFICATION RESPONSE message or the like. Exemplary DRB to setup information may include a new bearer type indication in an explicit or implicit manner. In some cases, the exemplary DRB to setup information may also include allocated LCID for each PDU set type.

After receiving the new bearer type indication from the gNB-DU, the gNB-CU will trigger an F1-U tunnel setup for the new type DRB. In step 807, the gNB-CU will send the UL TNL information for each F1-U tunnel of each PDU set type to the gNB-DU, e.g., via a UE CONTEXT MODIFICATION REQUEST message. For example, the UL TNL information for each F1-U tunnel of each PDU set type includes the UL TNL information for the PDU set type indicating high importance and the UL TNL information for the PDU set type indicating less importance. In some cases, e.g., LCIDs being received from the gNB-DU, the gNB-CU may also include the LCIDs, each LCID corresponding to each UL TNL information used for a F1-U tunnel of a corresponding PDU set type. In some other cases, the UL TNL information for a corresponding PDU set type may be identified in other manners, e.g., directly indicating the specific PDU set type for which the UL TNL information is used.

The UL TNL information for each F1-U tunnel of each PDU set type may be transmitted in other manners besides the above illustrated manner. In some cases, the gNB-CU may separately transmit first UL TNL information for one PDU set type of the different PDU set types and second UL TNL information for each of remaining PDU set types to the gNB-DU. The first UL TNL information may be transmitted with the PDU set type information, and the second UL TNL information may be transmitted after receiving the new bearer type indication. For example, the gNB-CU may transmit the first UL TNL information in the DRB to be setup information in step 801 as legacy, and after receiving the new bearer type indication, the gNB-CU will transmit the second UL TNL information to the gNB-DU in step 807. In the case that the gNB-CU transmits the first UL TNL information in the DRB to be setup information in step 801 as legacy, the gNB-DU may indicate to gNB-CU that the first UL TNL information is used for which PDU set type in the setup 805.

In step 809, the gNB-DU will provide DL TNL information for each F1-U tunnel of each PDU set type to the gNB-CU, e.g., via a UE CONTEXT MODIFICATION RESPONSE message. For example, considering two PDU set types of high importance and less importance, the DL TNL information for each F1-U tunnel of each PDU set type may include: the DL TNL information for the PDU set type indicating high importance and the DL TNL information for the PDU set type indicating less importance. Similarly, in some cases, e.g., LCIDs being received from the gNB-DU, the gNB-CU may also include the LCIDs, each LCID corresponding to each DL TNL information used for a corresponding PDU set type. In some other cases, the DL TNL information for a corresponding PDU set type may be identified in other manners, e.g., directly indicating the specific PDU set type for which the DL TNL information is used.

Similarly, the DL TNL information for each F1-U tunnel of each PDU set type may be transmitted in other manners. For example, the gNB-DU may transmit the DL TNL information for each F1-U tunnel of each PDU set type with the new bearer type indication to the gNB-CU in step 805. In some other cases, the gNB-DU may separately transmit first DL TNL information for one PDU set type of the different PDU set types and second DL TNL information for each of remaining PDU set types to the gNB-DU. The first DL TNL information is transmitted with the new indication, and the second DL TNL information is transmitted after receiving the second UL TNL information. For example, the gNB-DU may transmit the first DL TNL information in the DRB to setup information in step 805 as legacy, and after receiving the UL TNL information for each F1-U tunnel of each PDU set type or after separately receiving the second UL TNL information, the gNB-DU will transmit the second DL TNL information to the gNB-CU in step 809.

After the new type DRB is setup, data transmission will be performed over the F1 interface in the step 811, which is similar to step 609 and thus will not repeat.

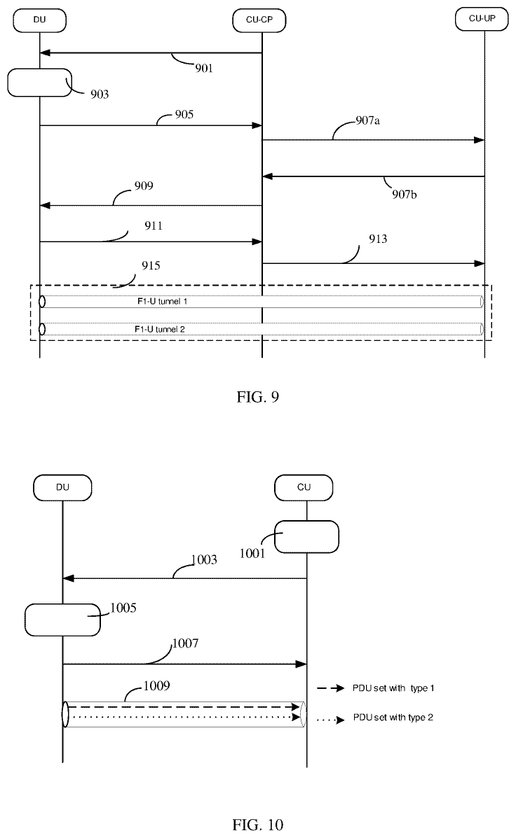

Considering the cases of a split CU, embodiments illustrated in view of FIG. 8 can be further detailed within the CU as shown in FIG. 9. Specifically, FIG. 9 is a flow chart illustrating a method of data transmission in Scenario 2 according to some other embodiments of the present application, wherein a plurality of F1-U tunnels are provided for the new type DRB.

Referring to FIG. 9, the CU of a RAN node, e.g., a gNB-CU is separated into a CU-CP and at least one CU-UP coupled to the CU-CP (only one is illustrated as an example). Similarly, although the method is illustrated in a system level between the CU of the RAN node e.g., a gNB-CU and a DU coupled to the CU, e.g., a gNB-DU, persons skilled in the art should understand that the method implemented in the CU and the DU can be separately implemented and/or incorporated by other apparatus with the like functions.

Similar to FIG. 7, communication for DRB setup between the CU and DU illustrated in FIG. 8 will be performed between the CU-CP and DU, while data transmission between the CU and DU after the DRB setup illustrated in FIG. 8 will be performed between the CU-UP and DU. Based on that, steps 901, 901 and 905 are identical or similar to steps 801, 803 and 805 in FIG. 8, steps 909 and 911 are identical or similar to steps 807 and 809, step 915 is identical or similar to step 811, and thus will not repeat. Regarding communication between the CU-CP and CU-UP, it will be illustrated in the following.

In step 907a, after receiving the new bearer type indication from the DU, the CU-CP will send the new bearer type indication to the CU-UP over E1 interface, e.g., included in DRB to Be Setup IE or the like, via a BEARER CONTEXT SETUP REQUEST message. The CU-CP may also transmit PDU set type information indicating different PDU set types carried by the DRB to the CU-UP, e.g., also included in the DRB to Be Setup IE or the like. In some other embodiments of the present application, the CU-CP may transmit the PDU set type information to the CU-UP before receiving the new bearer type indication. In the case that LCIDs are received from the DU, the CU-CP may also send the LCIDs to the CU-UP. In the case that the DL TNL information for each F1-U tunnel of each PDU set type or only the first DL TNL information is received, the CU-CP will also transmit the DL TNL information for each F1-U tunnel of each PDU set type or only the first DL TNL information to the CU-UP.

After receiving the new bearer type indication, the CU-UP will allocate UL TNL information for each F1-U tunnel of each PDU set type similar to that stated in FIG. 6, which may be based on the PDU set type information or LCIDs etc. The CU-UP will send the UL TNL information for each F1-U tunnel of each PDU set type to the CU-CP in step 907b, e.g., via a BEARER CONTEXT SETUP RESPONSE message. In some other embodiments of the present application, the CU-CP may request first UL TNL information as legacy before step 901 so that the first UL TNL information can be transmitted in DRB to be setup information in step 901. Accordingly, the CU-UP may only send the second UL TNL information to the CU-CP in step 907b.

After receiving the DL TNL information for each F1-U tunnel of each PDU set type from the DU in step 911, the CU-CP will transmit the DL TNL information for each F1-U tunnel of each PDU set type to the CU-UP in step 913. In some cases, e.g., the first DL TNL information has been received in step 905, the CU-UP may only receive the second DL TNL information in step 911, and will send only the second DL TNL information to the CU-UP.

In addition, according to some other embodiments of the present application, there will be only one F1-U tunnel between the CU and DU corresponding to all the different PDU set types, which is applicable either in Scenario 1 or in Scenario 2. Compared with the cases of multiple F1-U tunnels, UL TNL information and DL TNL information is associated with the only one F1-U tunnel, which is as the same as the legacy. Operations on the CU, even in the case of a split CU are similar to that of multiple F1-U tunnels or the legacy. However, the DU needs to allocate multiple RLC entities and logical channels, each RLC entity and logical channel corresponding to a PDU set type.

Taking Scenario 1 as an example, FIG. 10 is a flow chart illustrating a method of data transmission in Scenario 1 according to some yet other embodiments of the present application, wherein there is only one F1-U tunnel between the CU and DU corresponding to all the different PDU set types. Although the method is illustrated in a system level between the CU of the RAN node, e.g., a gNB-CU and a DU coupled to the CU, e.g., a gNB-DU, persons skilled in the art should understand that the method implemented in the CU and the DU can be separately implemented and/or incorporated by other apparatus with the like functions.

Referring to FIG. 10, the gNB-CU may decide to apply a new bearer type of a DRB in step 1001 in some cases, e.g., in response to QoS flow information or QoS parameters of PDU sets from the CN.

In step 1003, the gNB-CU will send DRB to be setup information, e.g., DRB to Be Setup IE to a gNB-DU coupled to the gNB-CU for setup of the new type DRB. The DRB to be setup information may be included in a UE CONTEXT SETUP REQUEST message or UE CONTEXT MODIFICATION REQUEST message or the like. Exemplary DRB to be setup information may include a new bearer type indication indicating that the new bearer type is applied for the DRB. The exemplary DRB to be setup information may also include PDU set type information, indicating different PDU set types carried by the DRB in various manners. The UL TNL information for the F1-U tunnel to the gNB-DU may also be included in the DRB to be setup information.

After receiving the new bearer type indication, the gNB-DU will be aware that the new type DRB is to be setup. The gNB-DU will allocate related parameters for the new bearer type DRB in step 1005. For example, considering two PDU set types, the gNB-DU allocates two RLC entities and two logical channels (or LCIDs) for the new type DRB, each RLC entity and logical channel (or, LCID) is for a corresponding PDU set type. The modes of the RLC entities and the priorities of the logical channels will be configured according to the PDU set type information. The gNB-DU will also allocate or determine DL TNL information for the F1-U tunnel.

The gNB-DU will transmit DRB to setup information, e.g., DRB to Setup IE to the gNB-CU in step 1007. The DL TNL information for each F1-U tunnel of each PDU set type may be included in the DRB to setup information.

After the new type DRB is setup, data transmission will be performed over the F1 interface in step 1009.

Specifically, in the case of receiving a plurality of PDU sets with different PDU set types, e.g., PDU sets with type 1 and PDU sets with type 2 belonging to a traffic (e.g., XR services) from a core network, the gNB-CU will map the plurality of PDU sets to the setup DRB in the SDAP entity. After processing by the PDCP entity, the gNB-CU will send PDCP PDUs of the plurality of PDU sets to the gNB-DU via the only one F1-U tunnel. The gNB-DU will identify the different types of PDU sets according to specific PDU set type indication, which may be included in the header of the common F1-U tunnel. Then, the gNB-DU will map the received PDCP PDUs of PDU sets with different types to the corresponding RLC entities and logical channels for transmitting the data to UE.

In the case of a plurality of PDU sets with the different PDU set types, e.g., PDU sets with type 1 and PDU sets with type 2 belonging to a traffic (e.g., XR services) from a UE, the gNB-DU will transmit PDCP PDUs of the plurality of PDU sets to the gNB-CU via the only one F1-U tunnels.

However, in the cases that there is only one F1-U tunnel between the CU and DU corresponding to all the different PDU set types, since the new type DRB is served by multiple RLC entities and multiple logical channels, it would be better to report flow control information of each PDU set type in order that the CU can know the transmission status for each PDU set type. As specified in TS 38.425, the flow control information is provided by NR user plane protocol data which is conveyed by GTP-U protocol means, more specifically, by means of the “NR RAN Container” GTP-U extension header as defined in TS 29.281.

According to some embodiments of the present application, the flow control information for each PDU set type indicates at least one of the following information: a highest PDCP PDU sequence number successfully delivered in sequence to a UE of a PDU set type; a highest PDCP PDU sequence number transmitted to lower layers of a PDU set type; or a desired buffer size for the PDU set type of the DRB.

According to some embodiments of the present application, the flow control information for the new type DRB is indicated in a downlink data delivery status frame with a PDU set type indication, wherein the PDU set type indicates a specific PDU set type, e.g., PDU set type 1 indicating high importance or PDU set type 2 indicating low importance. In some embodiments of the present application, the flow control information for the new type DRB is provided in a new frame of the NR user plane protocol with a PDU set type indication, wherein the PDU set type indicates a specific PDU set type. In some embodiments of the present application, flow control information for different PDU set types is provided by different frames of the NR user plane protocol, e.g. the flow control information of PDU set type 1 is provided by frame 1, while the flow control information of PDU set type 2 is provided by frame 2.

Table 1 shown below illustrates an exemplary downlink data delivery status frame with a PDU set type indication (hereafter, new downlink data delivery status frame). Compared with a legacy downlink data delivery status frame, the new downlink data delivery status frame includes: “PDU set type indication” with one bit, “desired buffer size for the indicated PDU set type” with one byte; “highest successfully delivered PDCP sequence number for the indicated PDU set type” with one byte; and “highest transmitted PDCP sequence number for the indicated PDU set type” with one byte.

TABLE 1

| Bits | | | | | | | | Number |
|---|---|---|---|---|---|---|---|---|
| 7 | 6 | 5 | 4 | 3 | 2 | 1 | 0 | of Octets |
| PDU Type (=1) | | | | Highest | Highest | Final | Lost | 1 |
| | | | | Trans- | Deli- | Frame | Packet | |
| | | | | mitted | vered | Indi- | Report | |
| | | | | NR | NR | cation | | |
| | | | | PDCP | PDCP | | | |
| | | | | SN | SN | | | |
| | | | | Indi- | Indi- | | | |
| | | | | cation | cation | | | |
| Spare | | | | PDU | Retrans- | Deli- | Cause | 1 |
| | | | | set | mitted | vered | Report | |
| | | | | type | NR | Retrans- | | |
| | | | | indi- | PDCP | mitted | | |
| | | | | cation | SN | NR | | |
| | | | | | Indi- | PDCP | | |
| | | | | | cation | SN | | |
| | | | | | | Indi- | | |
| | | | | | | cation | | |

| | |
|---|---|
| Desired buffer size for the indicated PDU set type | 4 |
| Highest successfully delivered PDCP Sequence | 0 or 3 |
| Number for the indicated PDU set type | |
| Highest transmitted PDCP Sequence | 0 or 3 |
| Number for the indicated PDU set type | |
| Padding | 0-3 |

In some embodiments of the present application, all flow control information for different PDU set types carried by a new type DRB can be included in the same downlink data delivery status frame, wherein a plurality of PDU set types can be indicated by the PDU set type indication with one or more bits. For example, two bits can be used for the PDU set type indication, value “00” means PDU set type 1, value “01” means PDU set type 2, and value “10” means both the PDU set type 1 and PDU set type 2. Other related fields associated with each indicated PDU set types, e.g., at least one of “desired buffer size for the indicated PDU set type”; “highest successfully delivered PDCP sequence number for the indicated PDU set type”; and “highest transmitted PDCP sequence number for the indicated PDU set type” etc. can be further included in sequence in the downlink data delivery status frame similar to those illustrated in Table 1.

In some other embodiments of the present application, when feeding back the flow control information to the gNB-CU, the gNB-DU may only considers the transmission status of one PDU set type, e.g., the PDU set type indicating high importance.

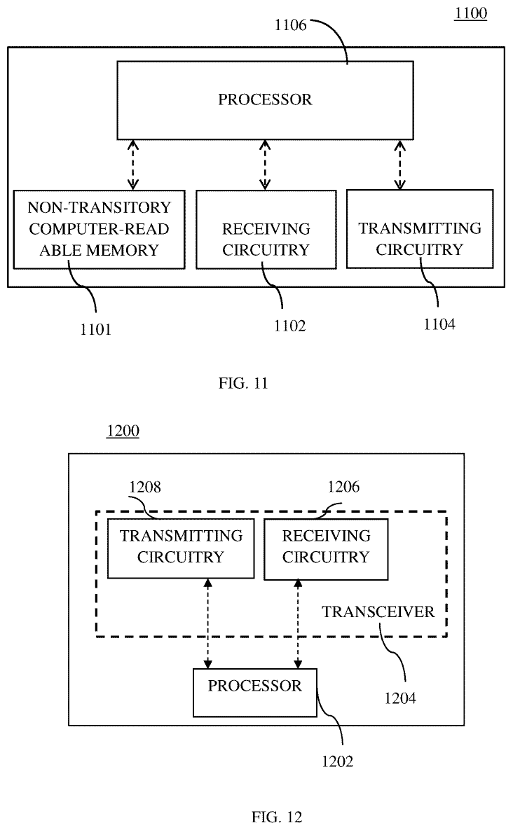

Besides methods, embodiments of the present application also propose an apparatus of data transmission. FIG. 11 is a block diagram of an apparatus of data transmission according to some embodiments of the present application.

As shown in FIG. 11, the apparatus 1100 may include at least one non-transitory computer-readable medium 1101, at least one receiving circuitry 1102, at least one transmitting circuitry 1104, and at least one processor 1106 coupled to the non-transitory computer-readable medium 1101, the receiving circuitry 1102 and the transmitting circuitry 1104. The apparatus 1100 may be a CU or DU configured to perform a method illustrated in the above or the like.

Although in this figure, elements such as the at least one processor 1106, transmitting circuitry 1104, and receiving circuitry 1102 are described in the singular, the plural is contemplated unless a limitation to the singular is explicitly stated. In some embodiments of the present application, the receiving circuitry 1102 and the transmitting circuitry 1104 can be combined into a single device, such as a transceiver. The processor 1106 may be a central processing unit (CPU), a digital signaling processing (DSP), a microprocessor etc. In certain embodiments of the present application, the apparatus 1100 may further include an input device, a memory, and/or other components.

In some embodiments of the present application, the non-transitory computer-readable medium 1101 may have stored thereon computer-executable instructions to cause the processor 1106 to implement the method with respect to the CU or DU as described above. For example, the computer-executable instructions, when executed, cause the processor 1106 interacting with receiving circuitry 1102 and transmitting circuitry 1104, so as to perform the steps with respect to a CU or DU as depicted above.

FIG. 12 illustrates a block diagram of an apparatus 1200 of data transmission according to some other embodiments of the present application.

Referring to FIG. 12, the apparatus 1200, e.g., a CU or DU may include at least one processor 1202 and at least one transceiver 1204. The transceiver 1204 may include at least one separate receiving circuitry 1206 and transmitting circuitry 1208, or at least one integrated receiving circuitry 1206 and transmitting circuitry 1208. The at least one processor 1202 may be a CPU, a DSP, a microprocessor etc.

According to some embodiments of the present application, when the apparatus 1200 is an CU, the processor may be configured to: determine to apply a first bearer type of a DRB to transmit a plurality of PDU set types; and transmit, to a DU of the RAN node, an indication of the first bearer type of the DRB, and PDU set type information associated with different PDU set types; wherein, the first bearer type of the DRB is served by a plurality of logical channels, and each logical channel is for transmitting a respective one of the PDU set types.

According to some other embodiments of the present application, when the apparatus 1200 is an CU, the processor may be configured to: transmit, to a DU of the RAN node, PDU set type information associated with a plurality of PDU set types; and receive, from the DU, an indication of a first bearer type of a DRB; wherein the first bearer type of the DRB is associated with a plurality of logical channels, and each logical channel is for transmitting a respective one of the PDU set types.

According to some yet other embodiments of the present application, when the apparatus 1200 is an DU, the processor may be configured to: receive, from a CU of the RAN node, PDU set type information associated with a plurality of PDU set types; determine to apply a first bearer type of a DRB for a plurality of PDU set types; and transmit, to the CU, an indication of the first bearer type of the DRB; wherein the first bearer type of the DRB is associated with a plurality of logical channels, and each logical channel is for transmitting a respective one of the PDU set types.

According to some yet other embodiments of the present application, when the apparatus 1200 is an DU, the processor may be configured to: receive, from a CU of the RAN node, an indication of a first bearer type of a DRB and PDU set type information associated with different PDU set types, wherein, the first bearer type of the DRB is served by a plurality of logical channels, and each logical channel is for transmitting a respective one of the PDU set types; and allocate different logical channels for different PDU set types based on the indication of the first bearer type of the DRB and the PDU set type information.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as random access memory (RAMs), read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A central unit (CU) of a radio access network (RAN) node, comprising:
at least one memory; and
at least one processor coupled with the at least one memory and configured to cause the CU to:
determine to apply a first bearer type of a data radio bearer (DRB) to transmit a plurality of protocol data unit (PDU) set types; and
transmit, to a distributed unit (DU) of the RAN node, an indication of the first bearer type of the DRB, and PDU set type information associated with the plurality of PDU set types, wherein the first bearer type of the DRB is served by a plurality of logical channels, and each logical channel is for transmitting a respective one of the PDU set types.

2. The CU according to claim 1, wherein a plurality of F1 user-plane (F1-U) tunnels are used for PDU set types between the CU and the DU, and each F1-U tunnel corresponds to a PDU set type.

3. The CU according to claim 2, wherein the at least one processor is further configured to cause the CU to:
transmit, to the DU, uplink transport network layer (TNL) information for each F1-U tunnel of each PDU set type; and
receive, from the DU, downlink TNL information for each F1-U tunnel of each PDU set type, wherein the uplink TNL information for each F1-U tunnel of each PDU set type includes first uplink TNL information for one PDU set type and second uplink TNL information for each of remaining PDU set types, and the downlink TNL information for each F1-U tunnel of each PDU set type includes first downlink TNL information for the one PDU set type and second downlink TNL information for each of the remaining PDU set types.

4. The CU according to claim 1, wherein one common F1-U tunnel is used for the plurality of PDU set types between the CU and the DU.

5. The CU according to claim 4, wherein the at least one processor is configured to cause the CU to receive flow control information corresponding to each PDU set type from the DU.

6. The CU according to claim 5, wherein the flow control information indicates at least one of:
a highest packet data convergence protocol (PDCP) PDU sequence number successfully delivered in sequence to a user equipment (UE) of a PDU set type;
a highest PDCP PDU sequence number transmitted to lower layers of a PDU set type; or
a desired buffer size for the PDU set type of the DRB.

7. The CU according to claim 5, wherein the flow control information is indicated in a downlink data delivery status frame with a PDU set type indication.

8. The CU according to claim 1, wherein the plurality of PDU set types have different importance.

9. A distributed unit (DU) of a radio access network (RAN) node, comprising:
at least one memory; and
at least one processor coupled with the at least one memory and configured to cause the DU to:
receive, from a central unit (CU) of the RAN node, protocol data unit (PDU) set type information associated with a plurality of PDU set types;
determine a first bearer type of a data radio bearer (DRB) for the plurality of PDU set types; and
transmit, to the CU, an indication of the first bearer type of the DRB, wherein the first bearer type of the DRB is associated with a plurality of logical channels, and each logical channel is for transmitting a respective one of the PDU set types.

10. The DU according to claim 9, wherein a plurality of F1-U tunnels are used for PDU set types between the CU and DU, and each F1-U tunnel corresponds to a PDU set type.

11. The DU according to claim 10, wherein the at least one processor is further configured to cause the DU to:
receive, from the CU, uplink transport network layer (TNL) information for each F1-U tunnel of each PDU set type; and
transmit, to the CU, downlink TNL information for each F1-U tunnel of each PDU set type, wherein the uplink TNL information for each F1-U tunnel of each PDU set type includes first uplink TNL information for one PDU set type and second uplink TNL information for each of remaining PDU set types, and the downlink TNL information for each F1-U tunnel of each PDU set type includes first downlink TNL information for the one PDU set type and second downlink TNL information for each of the remaining PDU set types.

12. The DU according to claim 9, wherein one common F1 user-plane (F1-U) tunnel is used for the plurality of PDU set types between the CU and DU.

13. The DU according to claim 12, wherein the at least one processor is configured to cause the DU to transmit flow control information corresponding to each PDU set type to the CU.

14. The DU according to claim 13, wherein the flow control information indicates at least one of:
a highest packet data convergence protocol (PDCP) PDU sequence number successfully delivered in sequence to a user equipment (UE) of a PDU set type;
a highest PDCP PDU sequence number transmitted to lower layers of a PDU set type; or
a desired buffer size for the PDU set type of the DRB.

15. The DU according to claim 13, wherein the flow control information is indicated in a downlink data delivery status frame with a PDU set type indication.

16. A method performed by a central unit (CU) of a radio access network (RAN) node, the method comprising:
determining to apply a first bearer type of a data radio bearer (DRB) to transmit a plurality of protocol data unit (PDU) set types; and
transmitting, to a distributed unit (DU) of the RAN node, an indication of the first bearer type of the DRB, and PDU set type information associated with the plurality of PDU set types, wherein the first bearer type of the DRB is served by a plurality of logical channels, and each logical channel is for transmitting a respective one of the PDU set types.

17. The method of claim 16, wherein a plurality of F1 user-plane (F1-U) tunnels are used for PDU set types between the CU and the DU, and each F1-U tunnel corresponds to a PDU set type.

18. The method of claim 16, wherein one common F1-U tunnel is used for the plurality of PDU set types between the CU and the DU.

19. The method of claim 18, further comprising:
receiving flow control information corresponding to each PDU set type from the DU.

20. A method performed by a distributed unit (DU) of a radio access network (RAN) node, the method comprising:
receiving, from a central unit (CU) of the RAN node, protocol data unit (PDU) set type information associated with a plurality of PDU set types;
determining a first bearer type of a data radio bearer (DRB) for a plurality of PDU set types; and
transmitting, to the CU, an indication of the first bearer type of the DRB, wherein the first bearer type of the DRB is associated with the plurality of logical channels, and each logical channel is for transmitting a respective one of the PDU set types.
